(19) United States
(12) Patent Application Publication
(10) Pub. No.: US 2008/0010081 A1
(43) Pub. Date: Jan. 10, 2008

(54) Method for conducting private, non-adversarial, uncompromised, legal dispute investigation and resolution

(76) Inventor: Robert Christopher, Morgan Hill, CA (US)

Correspondence Address: JACOBSON HOLMAN PLLC, 400 SEVENTH STREET N.W., SUITE 600, WASHINGTON, DC, 20004, US

(21) Appl. No.: 11/822,346

(22) Filed: Jul. 5, 2007

Related U.S. Application Data
(60) Provisional application No. 60/818,286, filed on Jul. 5, 2006.

(51) Int. Cl. G06Q 90/00

(52) U.S. Cl. 705/1

(57) ABSTRACT

A method for conducting private, non-adversarial, legal dispute investigation and resolution includes a contract step for bringing together at least two disputing parties having a dispute and a dispute resolution service acting in a neutral, non-representative role with respect to the disputing parties for identifying tasks and procuring expertise necessary to investigating and resolving the dispute, a resolution team selection step for performing the necessary tasks identified in the contract step and procuring expertise in the form of a dispute resolution team to resolve the dispute, and a resolution step for investigating and resolving the dispute using the dispute resolution team.

### CROSS-REFERENCE TO RELATED APPLICATIONS

The present patent application is based on, and claims priority from, U.S. provisional Application No. 60/818,286, filed Jul. 5, 2006, which is incorporated herein by reference in its entirety.

### BACKGROUND OF THE INVENTION

1. Field of the Invention

The present invention relates to a dispute resolution method. More specifically, the invention relates to a dispute resolution method in which the parties together select and use a neutral team of highly reputable legal and industry experts to investigate and decide the dispute consistent with legal principles.

2. Related Art

Disagreements that mature into legal disputes are inevitable in contemporary society. Most people despise legal disputes for good reason: Legal disputes and the process of their resolution have high out-of-pocket attorneys' fees and related costs—often greater than the value of what is at stake and sufficient to turn potentially profitable endeavors into losses—and they have real and substantial hidden costs due to unproductive diversion of resources and energy, interruption or paralysis in planning that often accompanies delay and uncertainty, and loss of reputation and/or relationships. These hidden costs also include important emotional, ego, and stress-related considerations arising from legitimate feelings of violation, indignation, and frustration.

Current conventional methods of legal dispute resolution often are inadequate to the pace and needs of personal and business interactions in the 21st Century.

The state-supported judicial system is slow, costly, and cumbersome. Its potential demands on cash flow, as well as its ultimate costs to all parties, are indeterminate both at the outset and during the process. Attorneys functioning as advocates in adversarial relationships search and maneuver endlessly for incremental advantage, particularly in the confrontational discovery process and motions practice that are inherent parts of the litigation process. Substantial lead times are required for briefing and hearing schedules on all procedural and substantive disputes. Opposing sides retain experts motivated to analyze issues from biased perspectives. The only neutral participants, judges, have little pro-active authority to direct the discovery or procedural process in a manner that minimizes waste and maneuvering. Moreover, they sometimes are inexperienced with the subject matter, and may delay definitive decisions for a host of reasons. Finally, juries are seldom composed of informed peers, and their use contributes to delay and multiplies the opportunities for procedural legal error.

Those parties who have turned to privately financed arbitration often find it suffers from many of the same maladies as the judicial system because it consists of the same structural and procedural elements of adversarial process, sans jury: Opposing attorneys, reactive neutrals, advocating experts, multiple rounds of briefing, and procedural rules that create opportunity for additional cost and delay.

Forms of dispute resolution that rely on voluntary settlement, like direct negotiation and mediation (facilitated negotiation), can be relatively fast and inexpensive, but may not succeed. When they do succeed, they usually require compromise of principle and loss of opportunity for each party's position to be fully investigated and adjudged. These compromise-based methods of dispute resolution can be distasteful and frustrating to economically rational parties with otherwise meritorious positions. Mediation typically takes place, if at all, after a dispute has entered the adversarial process, and so it too is subject to all of that process' shortcomings up until the time the parties reach settlement. If mediation fails, total time and cost to resolution may even be higher than without it, although many failed mediations do enable the opposing parties and their attorneys to better focus their subsequent efforts.

Consequent to the above-described shortcomings of the adversarial process, many informed businesses and individuals will reluctantly forego pursuing any vindication of valuable legal rights just to avoid the accompanying distractions, stress, time, costs, and risks to relationships and reputation.

The primary obstacle to faster, cheaper, and easier high-quality dispute resolution is the adversarial process, and there is a growing perception and recognition in American society that this is the case. This process compels each party to hire its own attorney advocate to investigate and fight the party's case through a maze of procedural obstacles and opportunities, which each attorney is obligated (and financially motivated) to employ in the best interests of his or her client, regardless of the overall merits of the dispute, in order to obtain the best possible final outcome for that client. Opportunities and incentives for maneuver, gamesmanship, and confrontation are legion, each one potentially necessitating multiple rounds of costly communication, briefing, delay, argument, and neutral intervention. Waiting time fills like a vacuum with new tasks. Opposing attorney and party egos conflict, take offense, bait each other, and/or retaliate, too often at the expense of sound judgment and efficiency. Because of these opportunities and incentives, there also is extraordinary potential for unfair advantage and other mischief by parties or attorneys who are overly aggressive, economically powerful, or relatively unscrupulous. If financial, technical, industry, or other non-legal expertise is needed, the process also forces each party to hire its own experts who, at best, have a subconscious bias to favor the party who hired them. Each participant in the adversarial process—party, opposing party, attorney, opposing attorney, expert, and judge (or other neutral) has a different and potentially conflicting perspective or goal. Of those participants, only the judge is truly responsible to act fairly and in the best interests of justice, yet his or her role is principally reactive, and consequently seldom can be employed to take initiative to direct or focus the process in an efficient, just or productive manner.

Of course, herein lies the oft-touted theoretical benefit of the adversarial process—that each participant's different, conflicting duty, together with the opportunity to confront each other before a judicial authority, provides reasonable assurance that each party's position will be adequately investigated and explored, and its story presented as effectively as possible, with justice the result. That is, the adversarial system is supposed to work much like a market economy, with most participants contributing to the greater good by pursuing their own best interests within a system in which real authority is non-existent or widely diffused.

In sum, the adversarial process takes too long, costs too much, and is susceptible to serious abuse. It is particularly damaging and destructive to business, the success of which often depends on coordination of effort and inputs within limited windows of opportunity.

This adversarial process may be unavoidable in many situations if disputing parties are to resolve disputes civilly and without violence, but if a credible and highly professional service were to offer an alternative method for resolving legal disputes that provides at least comparable quality investigation and principled neutral decision-making in a fraction of the time and at a fraction of the out-of-pocket and hidden costs compared with the adversarial system, it is highly likely that some opposing parties would find compelling the benefits of using this tool in appropriate cases. Appropriate cases likely include, for example, situations in which (1) the opposing parties each believe in the moral and legal legitimacy of their conduct generally, and in the merits of their positions in particular, either before or at the outset of any dispute, (2) the parties desire to preserve (post-dispute) a productive relationship with each other, (3) the likely costs of resolution by other methods may exceed the stakes in dispute, and/or (4) swift and principled resolution, even if adverse, is perceived as better than slow and costly victory. In other words, there is need for and value in a means of dispute resolution that preserves the best and necessary elements of the judicial system while avoiding its costly inefficiencies.

Known methods of non-adversarial dispute resolution are inappropriate or ineffective in many situations. Often called collaborative or cooperative dispute resolution, these methods employ attorneys and/or other advisors whose goal is to help disputing parties achieve a fair and agreed resolution of their dispute. These methods usually require both extraordinary trust and good faith, and ongoing and extensive cooperation between parties whose pecuniary or other interests are directly adverse. Like mediation, they typically also require negotiation, compromise, and ultimate agreement between parties on the final outcome. In some of these methods, each party still separately hires and pays his or her own attorney, although the attorney's role may be defined differently than in the adversarial process. Such methods have proved effective in family law contexts dominated by the interests of a few key individuals, but thus far have not gained wide acceptance in disputes involving businesses and other organizations in arms-length relationships.

It is to the solution of these and other problems that the present invention is directed.

### SUMMARY OF THE INVENTION

It is accordingly a primary object of the present invention to provide a dispute resolution method in which the parties together select and use a neutral team of highly reputable legal and industry experts to investigate and decide the dispute consistent with legal principles.

It is another object of the present invention to provide a dispute resolution method that resolves disputes in a fraction of the time, cost, stress, and lost productivity of adversarial dispute resolution forums like the court system, arbitration, and mediation.

It is still another object of the present invention to provide a dispute resolution method that eliminates formal discovery (e.g., depositions and interrogatories), discovery disputes, formal pleading and procedural disputes, evidentiary disputes, trial preparation, and extensive research, briefing, and hearing cycles.

It is still another object of the present invention to provide a dispute resolution method that provides parties with a real reduction in managerial and employee distraction from productive work, better opportunity to preserve valued reputations and relationships, fewer emotional escalators and lower stress, much lower, economically rational legal costs relative to the stakes, and resolution in days or weeks, instead of months or years.

It is still another object of the present invention to provide a neutral investigation and principled decision-making service that renders a final, binding decision within a schedule and budget (including a fixed and/or maximum fee) agreed upon by the parties.

These and other objects of the present invention are achieved by a method of private, non-adversarial, uncompromised legal dispute resolution comprising the steps of: disputing parties agreeing with each other and a neutral service to submit a dispute to the neutral service for cooperative investigation and resolution and to the consequences of the final decision rendered by the neutral service; retaining or employing a team of support and professional resources by the neutral service to investigate and resolve the dispute; learning and defining the nature, scope, principal issues, and investigative needs of the dispute by the neutral service; scheduling, coordinating, and managing the efforts of the neutral service; choosing and retaining a team of appropriate, qualified and neutral (unconflicted) support and expert professional resources by the neutral service to investigate and resolve the dispute; conducting investigation, research, and analysis of the principal facts and applicable substantive legal principles necessary to resolve the dispute on a principled basis consistent with fairness to all parties by the neutral team in a pro-active and cooperative manner; preparing and conveying to the parties in the legal dispute the proposed or tentative decision and explanation; providing an opportunity and process for the disputing parties to challenge or comment upon the tentative decision and for the neutral service, in its discretion, to undertake further inquiry, and to revise and/or adopt the tentative decision; and enforcing the parties' agreement, including the previously agreed consequences of the final decision rendered by the neutral service.

In one aspect of the present invention, the resolution team includes an odd number of ultimate decision-maker(s) authorized to resolve any differences among team members.

In another aspect of the present invention, the resolution team has absolute discretion concerning whether and how to use or apply evidentiary and other noncontractual procedural legal rules or processes.

In another aspect of the present invention, the method includes agreement to complete, and completion of, the resolution process within a specified time.

In another aspect of the present invention, the method includes agreement to complete, and completion of, the resolution process for a fixed or maximum fee.

In another aspect of the present invention, the method includes conducting mediation or other facilitated negotiation before or in lieu of final decision.

In another aspect of the present invention, the method includes a binding final decision, enforceable as a judgment in court.

In another aspect of the present invention, the method includes findings of fact and/or law in the tentative and final decisions.

In another aspect of the present invention, the method includes a limited appeal process conducted by the service. The limited appeal process includes a review of the record and final decision by two additional neutral judges, with the decision of a majority of all three neutral judges binding.

In another aspect of the present invention, the method includes limited appeal through the court system of any purported error of law appearing from the face of the final decision.

In another aspect of the present invention, the selection process for the neutral ultimate decision maker(s) and any other professional expert(s) includes disclosure to the parties of the identities and resumes of each candidate proposed by the Service, followed by the opportunity for each party to reject at least one such candidate.

In another aspect of the present invention, where a party uses its own attorney or other dispute resolution professional to interface with or provide information to the Service's neutral team at any stage of the process, the Service's neutral team shall recognize and compensate for such use, as necessary to offset any actual or potential advantage or unfairness owing to such use.

In another aspect of the present invention, if a party breaches the agreement, for example by failing to cooperate fully and promptly in the investigation, the Service may complete its investigation and may render its decision on the assumption that information withheld or delayed would have been materially unfavorable to the breaching party.

In another aspect of the present invention, the method includes assuring the confidentiality of proprietary or sensitive information.

In another aspect of the present invention, the method includes the parties releasing and waiving potential legal liability of the Service regarding any purported attorney-client relationship, “joint” representation, obligation of zealous representation, negligence, and the like.

In another aspect of the present invention, the method includes the Service terminating and withdrawing from the non-adversarial resolution process if insurmountable or difficult obstacles arise (e.g., need for cooperation of an independent and uncooperative third party).

Other objects, features, and advantages of the present invention will be apparent to those skilled in the art upon a reading of this specification including the accompanying drawings.

### BRIEF DESCRIPTION OF THE DRAWINGS

The invention is better understood by reading the following Detailed Description of the Preferred Embodiments with reference to the accompanying drawing figures, in which like reference numerals refer to like elements throughout, and in which:

FIGS. 1A through 1C together are a flow diagram illustrating the steps in the dispute resolution method in accordance with the present invention.

### DETAILED DESCRIPTION OF THE PREFERRED EMBODIMENTS

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

The inventive method in accordance with the present invention is a different and better way to avoid or resolve many kinds of legal disputes, which can be present disputes or a defined range of future disputes. It relies on a non-adversarial process to dramatically reduce the costs, time, compromise, and/or potential for abuse inherent in all other forums for legal dispute resolution, while preserving high quality investigation, analysis, and resolution comparable to that obtainable through the courts.

Essentially, in this method a single neutral service (“the Service”) is contracted by all interested parties when or before a dispute arises to investigate the facts and resolve the matter consistent with truth, fairness, and substantive legal principles (“law”), preferably on a binding basis. The method relies on experienced judges (or other trained neutral individuals), qualified attorneys, and/or other reputable experts (e.g. industry, technical, and/or accounting), as appropriate to the dispute, to investigate and decide the disagreement or dispute on a legally principled basis, employing a non-adversarial team approach that actively and purposefully seeks the fair and legally correct resolution of the dispute. The method consequently avoids jurisdictional disputes, venue disputes, pleading disputes, discovery disputes, evidentiary disputes, expensive formal appeals, all forms of legal maneuvering and delay, compromise, unnecessary briefing and hearings, and all other negative attributes of the adversarial system.

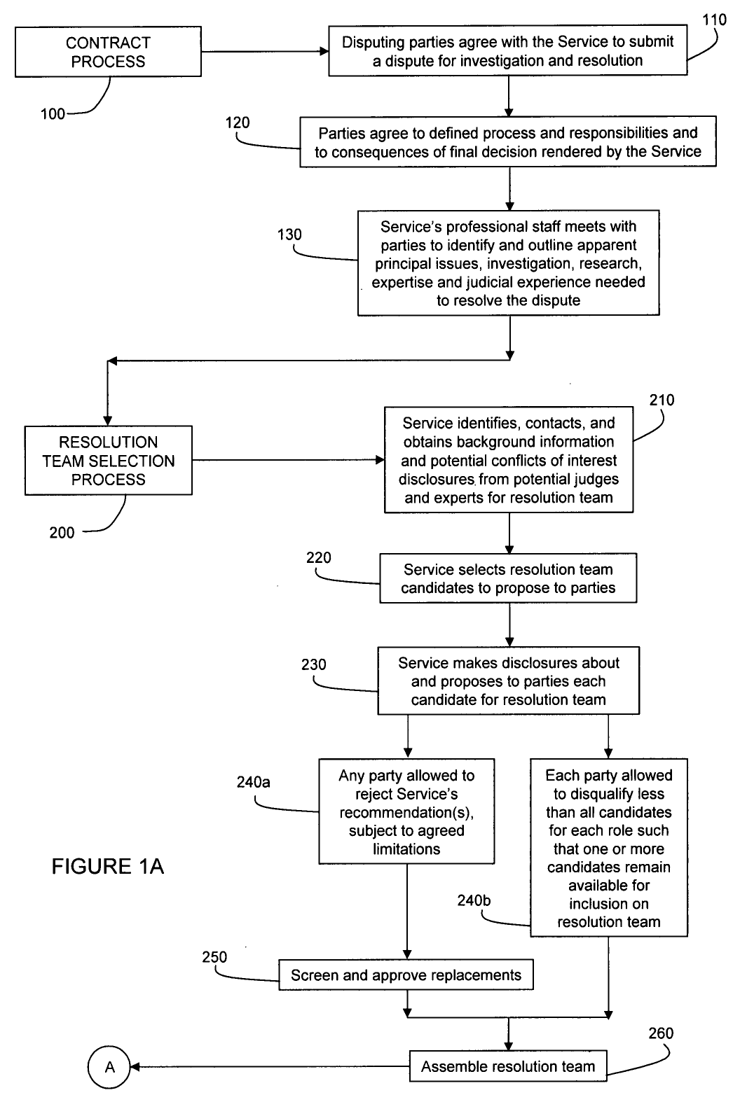

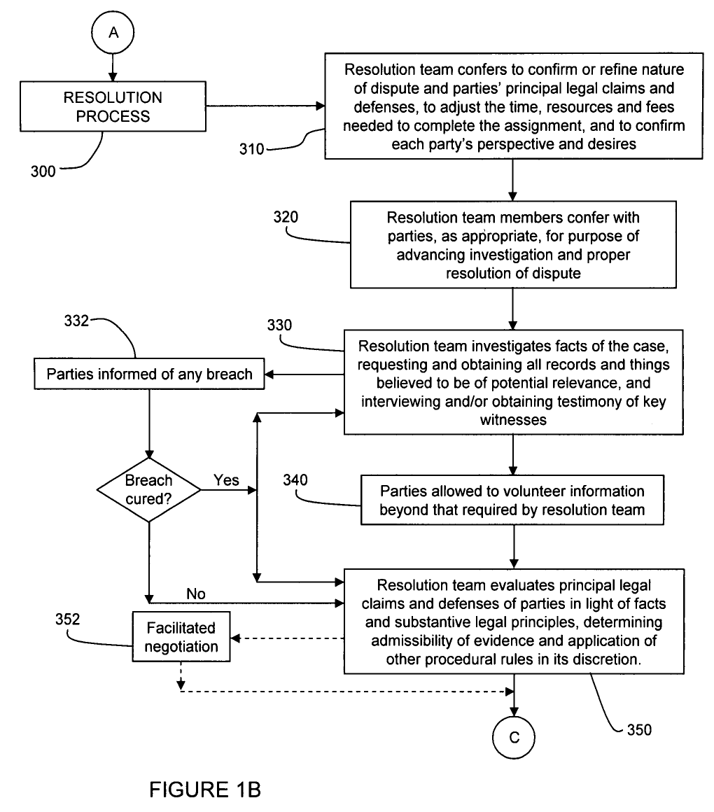

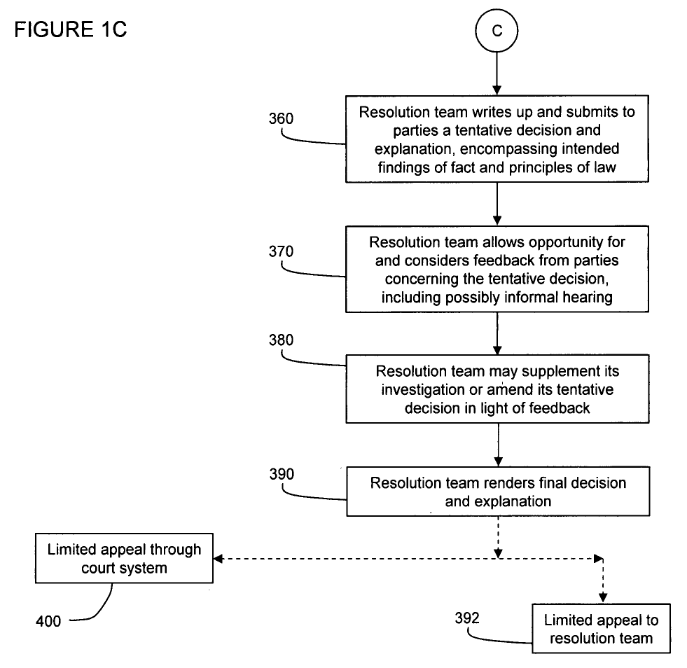

Referring now to FIGS. 1A-1C, the method has three principal components, a contract process 100, a resolution team selection process 200, and a resolution process 300; and works as follows: In the contract process 100, disputing parties agree with the Service to submit a present dispute or a defined range of future disputes (hereinafter referred to simply as a “dispute”) to the Service for investigation and binding (or nonbinding, if they elect) resolution (step 110). The parties agree to defined responsibilities, including the Service's neutral, non-representative role and their prompt and complete cooperation with the Service, and to a defined process including schedule, procedure, fixed or maximum or hourly-based fee, number of decision-makers, method of selection of judges and experts, role of tentative decisions, appealability, consequences of non-cooperation, payment and allocation of fees and costs, confidentiality, and other appropriate terms (step 120). As part of the contracting process 100, the Service's professional staff engages in intake and identification communications with the parties to identify and outline the apparent principal issues, investigation, research, expertise, and judicial experience needed to resolve the dispute (step 130). In the resolution team selection process 200 and the resolution process 300, the Service procures the necessary expertise and then performs the necessary tasks to resolve the dispute, including the following:

The Service identifies, contacts, and obtains background information and potential conflicts of interest disclosures from reputable and experienced judges (or other neutrals) and experts (including attorneys and non-legal experts as necessary) who are able and willing to contract with the Service to investigate and determine as a neutral team (the “resolution team”), and within agreed budgets of time and cost, the true material facts on behalf of both/all parties to the dispute, to apply those facts to law, and, ultimately, to render a decision with explanation (step 210). Candidates may include persons recommended by one or more of the parties. The Service then selects resolution team candidates to propose to the parties (step 220).

The Service makes appropriate disclosures about and proposes to the parties each candidate for the resolution team (step 230), and allows any party (e.g. preemptively for a fee, or for good cause) to reject the Service's recommendation(s), subject to previously agreed limitations (step 240a). Replacements for rejected candidates are similarly screened and approved. Alternatively, the Service informs the parties of the identities of team candidates for specific roles and allows each party to disqualify fewer than all candidates for each role such that one or more candidates remain available for inclusion on the team (step 240a). Once the candidates have been finalized, the resolution team is assembled (step 260). At least one resolution team member will serve as team leader and at least one member will serve as “judge” to act as final arbiter of any disagreements between or among team members.

Once the resolution team is assembled, the resolution process 300 takes place. The resolution team confers (step 310), and its members may confer further with the parties (step 320), either by agreement or in their discretion as the team perceives is appropriate, for the purpose of advancing the investigation and proper resolution of the dispute. In most instances, in step 310, the team will confer shortly after retention to confirm or refine the nature of the dispute and the parties' principal legal claims and defenses, to adjust—within previously agreed limits—the time, resources, and fees needed to complete the assignment, and to confirm each party's perspective and desires.

The Service (through its resolution team) investigates the facts of the case, requesting and obtaining from each party or third party witness any and all documents and other records believed to be of potential relevance, and interviewing and/or obtaining sworn testimony of key witnesses, recording the interviews and/or testimony by videotape or other means in its discretion (step 330).

Each party is free to volunteer information beyond that required by the Service (step 340), and each party is free to use whomever it wants to interface with or serve as a source of information to the Service, but the team shall recognize and compensate in its efforts if it appears that one party may gain undue advantage from such conduct or from such use of an attorney or other dispute resolution professional.

A party may use its own attorney or other dispute resolution professional to interface with or provide information to the Service's neutral team at any stage of the process. In such a case, the Service's neutral team shall recognize and compensate for such use, as necessary to offset any actual or potential advantage or unfairness owing to such use.

If the Service (through its resolution team) perceives that one party has breached its agreement, e.g. by failing to cooperate fully and promptly in the investigation, it so informs the parties (step 332), and, absent timely cure, it completes its investigation (step 350) and may render its decision on the assumption that the information withheld would have been materially unfavorable to the uncooperative party. As investigation (step 340) and evaluation (step 350), while functionally sequential, often involve jumping back and forth, the resolution process 300 may return to step 340 or step 350 if the breach is timely cured.

The Service (through its resolution team) evaluates the principal legal claims and defenses of the parties in light of the facts and law, determining admissibility of evidence and the application of other procedural rules in its discretion (step 350).

The Service (through its resolution team) writes up and submits to the parties a tentative decision and explanation, encompassing intended findings of fact and principles of law, although they need not be so denominated (step 360).

The Service allows opportunity for and considers any feedback from the parties concerning the tentative decision, including possibly an informal hearing (step 370). In its discretion, the Service (through its resolution team) may supplement its investigation or amend its tentative decision in light of this feedback (step 380).

The Service (through its resolution team) renders a final decision and explanation that, in the case of binding resolutions, may be confirmed in and enforced as a judgment by either party, with appropriate provisions to discourage unsuccessful legal challenge and/or to reimburse the fees and costs of enforcement (step 390).

Following rendering of the final decision, and if the parties have previously so agreed, any party has the option of requesting the Service (through its resolution team) to conduct a limited appeal process. The limited appeal process (step 392) includes a review of the record and final decision by two additional neutral judges in addition to the original resolution team judge or judges, with the decision of a majority of all three neutral judges binding.

The method can also include, as an alternative to the appeal conducted through the resolution team, a limited appeal through the court system, initiated by any party, of any purported error of law appearing from the face of the final decision (step 400). The appeal through the court system is a useful option only if and to the extent the courts of a given jurisdiction will accommodate it.

“Limited” is used with respect to both types of appeal as shorthand for the facts that the contract and procedural rules of the Service inherently limit the kinds of things that are subject to review, and the parties may agree in advance to what may be reviewable—findings of fact, or law, or both.

Modifications and variations of the above-described embodiments of the present invention are possible, as appreciated by those skilled in the art in light of the above teachings. For example, parties might agree to conducting mediation or other facilitated negotiation during the process, for example, before or in lieu of final decision (step 352), or to a limited appeal right involving representation by separate counsel. It is therefore to be understood that the invention may be practiced otherwise than as specifically described.

What is claimed is:

1. Method for conducting private, non-adversarial, legal dispute investigation and resolution, comprising:
a contract step for bringing together (a) at least two parties who desire a private, non-adversarial process for resolving at least one legal dispute arising between the at least two parties and (b) a dispute resolution service acting in a neutral, non-representative role for managing the process;
a resolution team selection step for procuring expertise in the form of a neutral dispute resolution team to resolve the dispute; and
a resolution step for investigating and resolving the dispute using the dispute resolution team.

2. The method of claim 1, wherein a party is permitted to use its own dispute resolution professional to at least one of interface with and provide information to the resolution team in any of the contract, resolution team selection, and resolution steps, and wherein the resolution team recognizes and compensates for the party's use of the dispute resolution professional, as necessary to offset any actual or potential advantage or unfairness owing thereto.

3. The method of claim 1, wherein the contract step comprises:
the parties agreeing to a defined process and responsibilities; and
carrying out communications among the dispute resolution service and the parties to identify and outline apparent principal issues, and the investigation, research, expertise, and judicial experience needed to resolve the dispute.

4. The method of claim 3, wherein the defined process and responsibilities include a neutral, non-representative role for the dispute resolution service, commitments of cooperation of the parties with the dispute resolution service, a schedule, procedure, fees, a method of selecting the dispute resolution team, use of tentative decisions that are subject to challenge and comment by the parties and to consequent reconsideration, appealability, consequences of non-cooperation by a party, payment and allocation of fees and costs, and confidentiality.

5. The method of claim 4, wherein the defined process and responsibilities include agreement by the parties to a budget, wherein the budget includes at least one of a fixed and maximum fee.

6. The method of claim 1, wherein the dispute resolution team selection step comprises:
the dispute resolution service identifying, contacting, and obtaining background information and potential conflicts of interest disclosures from persons who are able and willing to act as members of the dispute resolution team;
the dispute resolution service selecting candidates to propose to the parties for inclusion in the dispute resolution team;
the dispute resolution service making appropriate disclosures about and proposing to the parties the candidates for the dispute resolution team, including informing the parties of the identities of candidates for specific roles;
the parties providing input to the dispute resolution service regarding the proposed candidates;
the dispute resolution service finalizing the candidates based at least in part on the input of the parties; and
the dispute resolution service assembling the dispute resolution team from the candidates proposed by the dispute resolution service and based on the input provided by the parties.

7. The method of claim 6, wherein in the identifying, contacting, and obtaining step, at least one of the persons is recommended by at least one of the parties.

8. The method of claim 6, wherein in the identifying, contacting, and obtaining step, the persons agree to act within agreed budgets of time and cost.

9. The method of claim 6, wherein the step of the parties providing input includes any disputing party being allowed to reject at least one of the proposed candidates.

10. The method of claim 9, wherein the parties are allowed to reject at least one candidate for good cause or preemptively for a fee.

11. The method of claim 9, wherein the parties are allowed to reject candidates subject to previously agreed limitations.

12. The method of claim 6, further comprising the step of screening and approving replacement candidates, prior to the step of assembling the dispute resolution team.

13. The method of claim 6, wherein when the dispute resolution team is assembled, at least one dispute resolution team member is selected to serve as team leader and at least one member is selected to serve as final arbiter of any disagreements between members of the dispute resolution team.

14. The method of claim 1, wherein the resolution step comprises:
the dispute resolution team investigating the facts of the case, and requesting and obtaining from each of the parties and any third party witnesses information believed to be of potential relevance; and
the dispute resolution team evaluating the principal legal claims and defenses of the parties in light of the obtained information and law, and determining admissibility of evidence and the application of other procedural rules in its discretion.

15. The method of claim 14, wherein the resolution step further comprises the resolution team rendering a final decision after evaluating the principal legal claims and defenses of the parties, and determining admissibility of evidence and the application of other procedural rules in its discretion.

16. The method of claim 14, wherein the resolution step further comprises the dispute resolution team conducting facilitated negotiation.

17. The method of claim 16, wherein the resolution step further comprises the resolution team rendering a final decision after conducting the facilitated negotiation.

18. The method of claim 15, wherein the resolution step further comprises the resolution team conducting a limited appeal process following the step of rendering the final decision.

19. The method of claim 18, wherein the limited appeal process includes a review of the record and final decision by two additional neutral judges.

20. The method of claim 15, further including an appeal step for conducting a limited appeal through the court system of any purported error of law appearing from the face of the final decision.

21. The method of claim 14, further comprising the step of the dispute resolution team conferring to advance the investigation and resolve the dispute, prior to the investigating step.

22. The method of claim 21, wherein when the dispute resolution team confers, the dispute resolution team:
confirms or refines the nature of the dispute and the principal legal claims and defenses of the parties;
adjusts, within previously agreed limits, the time, resources, and fees needed to complete the assignment; and
confirms the perspectives and desires of each of the parties.

23. The method of claim 14, further comprising the step of members of the dispute resolution team conferring with the parties for the purpose of advancing the investigation and proper resolution of the dispute.

24. The method of claim 14, further comprising the step of the dispute resolution team, if perceiving that one of the parties has breached its agreement with the dispute resolution service by withholding information, informing the parties of the breach, and, absent timely cure, completing its investigation and rendering its decision on the assumption that the information withheld would have been materially unfavorable to the disputing party in breach.

25. The method of claim 14, further comprising the step of the dispute resolution team writing up and submitting to the parties a tentative decision and explanation;
the dispute resolution team allowing opportunity for and considering any feedback from the parties concerning the tentative decision; and
the dispute resolution team, in its discretion, supplementing its investigation or amending its tentative decision in light of the feedback.

26. The method of claim 25, wherein the tentative decision and explanation encompasses intended findings of fact and applicable principles or conclusions of law.

27. The method of claim 15, further comprising enforcing the final decision as one of an arbitration award and a judgment.

28. The method of claim 3, wherein the defined process and responsibilities include appropriate provisions for at least one of discouraging unsuccessful legal challenge and reimbursing the fees and costs of enforcement.

29. Method for conducting private, non-adversarial, legal dispute investigation and resolution, comprising:
at least two parties agreeing with a dispute resolution service acting in a neutral, non-representative role to submit a present or future dispute to the dispute resolution service for investigation and resolution;
the parties agreeing to defined responsibilities and a defined process;
staff of the dispute resolution service and the parties conferring to identify and outline apparent principal issues, and investigation, research, expertise, and judicial experience needed to resolve the dispute;
the dispute resolution service identifying, contacting, and obtaining background information and potential conflicts of interest disclosures from persons who are able and willing to act as members of the dispute resolution team;
the dispute resolution service selecting candidates to propose to the parties for inclusion on the dispute resolution team;
the dispute resolution service making appropriate disclosures about and proposing to the parties the candidates for the dispute resolution team;
the parties providing input to the dispute resolution service regarding the proposed candidates;
the dispute resolution service finalizing the candidates based at least in part on the input of the parties;
the dispute resolution service assembling the dispute resolution team from the candidates proposed by the dispute resolution service and based on the input provided by the parties;
the dispute resolution team investigating the facts of the case, and requesting and obtaining from each of the parties and any third party witnesses information believed to be of potential relevance; and
the dispute resolution team evaluating the principal legal claims and defenses of the parties in light of the obtained information and law, and determining admissibility of evidence and the application of other procedural rules in its discretion.

30. The method of claim 29, wherein the resolution step further comprises the resolution team rendering a final decision after evaluating the principal legal claims and defenses of the parties, and determining admissibility of evidence and the application of other procedural rules in its discretion.

31. The method of claim 29, wherein the resolution step further comprises the dispute resolution team conducting facilitated negotiation.

32. The method of claim 31, wherein the resolution step further comprises the resolution team rendering a final decision after conducting the facilitated negotiation.

33. Method for conducting private, non-adversarial, legal dispute investigation and resolution, comprising:
(a) an agreement step for reaching agreement among at least two parties and a neutral service to submit a dispute to the neutral service for cooperative investigation and resolution, wherein the neutral service is responsible for managing the process;
(b) an intake and identification step for learning and defining the nature, scope, principal issues, and investigative needs of the dispute by the neutral service;
(c) a selection step for choosing and retaining a team of neutral support and expert professional resources appropriate to the dispute by the neutral service to investigate and resolve the dispute, wherein the neutral team has an odd number of ultimate decision-makers authorized to resolve any differences among team members;
(d) a resolution step for carrying out cooperative investigation, discovery, research, and resolution by the neutral team of the principal facts and applicable substantive legal principles necessary to resolve the dispute on a principled basis consistent with the legal principles and with fairness to the parties;
(e) a step for preparing a tentative decision and explanation by the neutral team;
(e) a communication step for conveying to the parties in the legal dispute the tentative decision and explanation by the neutral team;
(g) a review step for allowing the parties to challenge or comment upon the tentative decision and for allowing the neutral team, in its discretion, to decide whether to undertake further inquiry, revise the tentative decision, or adopt the tentative decision; and
(h) a step for enforcing the parties' agreement.

34. The method of claim 33, wherein in the resolution step, the neutral team is given absolute discretion concerning whether and how to use or apply evidentiary and other non-contractual procedural legal rules or processes.

35. The method of claim 33, wherein the enforcing step includes enforcing any binding final decision rendered by the neutral team.
